(19) United States
(12) Patent Application Publication
(10) Pub. No.: US 2026/0348850 A1
(43) Pub. Date: Nov. 5, 2026

(54) OPTICAL CELL AND CONCENTRATION MEASURING APPARATUS PROVIDED WITH THE SAME

(71) Applicant: AMANO Co., Ltd., Iwata-city, Shizuoka (JP)

(72) Inventor: Takuya MIYASAKA, Shizuoka (JP)

(21) Appl. No.: 18/993,791

(22) PCT Filed: Jun. 7, 2023
(86) PCT No.: PCT/JP2023/021153

§ 371 Date: Feb. 2, 2026

(51) Int. Cl. G01N 21/59

(52) U.S. Cl. CPC G01N 21/59

(57) ABSTRACT

An optical cell receives a sample in measuring concentration of a sample by absorptiometry, which may enhance workability and measurement accuracy than conventional devices. An optical cell for housing a sample used in a concentration measuring apparatus for measuring concentration of the sample by absorptiometry includes a housing portion 21 having a longitudinal direction and a short direction in horizontal cross-section. The optical cell further includes a projection extending outward from a side along a longitudinal direction of the housing portion along a short direction.

### TECHNICAL FIELD

The present invention relates to an optical cell for housing a sample in measuring the concentration of a sample by absorptiometry, and a concentration measuring apparatus provided with the optical cell.

### BACKGROUND ART

In a medical site, medical instruments used in surgery and other procedures are cleaned, sterilized, and disinfected before reuse. For patient safety, endoscopes must be cleaned using a high-level disinfectant at a specified concentration after wiping off visible contamination (Reference: “Guidelines for Standardizing Cleansing and Disinfection of Gastrointestinal Endoscopes” published by Japan Gastroenterological Endoscopy Society, Japanese Association for Infectious Diseases).

Since disinfectants used for cleaning are relatively expensive, they are generally used repeatedly for a certain number of times or for a certain period of time, and upon their use, their concentration is measured to ensure that they have a specified concentration.

Patent Document 1 discloses a technique related to an apparatus for performing the concentration measurement of such disinfectant solutions by absorptiometry.

### PRIOR ART PUBLICATION

### Patent Documents

### Patent Document 1

Japanese Patent Application Publication 2005-69969

### SUMMARY OF THE INVENTION

### Problems to be Solved by the Invention

A concentration measuring apparatus for measuring concentration of a sample by absorptiometry is provided with an optical cell for housing the sample. The optical cell is removable from the apparatus and replaced after each use (disposable), which is the part most frequently touched by the user during measurement operations.

Further, the optical cell is to house the sample and affects measurement accuracy.

Thus, optical cell is a component that affects workability and measurement accuracy, and there is a need for an optical cell that can improve these points.

In view of the above, an object of the present invention is to provide an optical cell that can improve workability or measurement accuracy, and a concentration measuring apparatus provided with the optical cell.

### Means for Solving the Problem

### (Configuration 1)

An optical cell for housing a sample in a concentration measuring apparatus for measuring concentration of the sample by absorptiometry, the optical cell including a housing portion having a longitudinal direction and a short direction in horizontal cross-section and a projection extending outward from a longitudinal side of the housing portion along a short direction.

### (Configuration 2)

The optical cell of configuration 1, in which the projection forms a short extension extending outward along a short direction in a bottom surface shape of the housing portion.

### (Configuration 3)

The optical cell of configuration 1 or 2, in which the housing portion has a substantially rectangular shape in horizontal cross-section, and in which the projection is formed to extend a side along a short direction of the substantially rectangular shape.

### (Configuration 4)

The optical cell of any of configurations 1 to 3, including an injection inlet portion formed at an upper end of the optical cell with a cross-sectional area of horizontal cross-section formed larger than the housing portion.

### (Configuration 5)

The optical cell of configuration 4 including an introducing portion positioned between the injection inlet portion and the housing portion with a cross-sectional area of horizontal cross-section formed larger than the housing portion.

### (Configuration 6)

The optical cell of configuration 5, wherein a side of the housing portion and the introducing portion opposite to a side on which the projection is formed is formed as a continuous plane.

### (Configuration 7)

A concentration measuring apparatus including the optical cell according to configurations 1 to 6, including a receiving portion for receiving the optical cell, the receiving portion including a recess for receiving the projection only in a predetermined direction.

### (Configuration 8)

The concentration measuring apparatus of configuration 7, including a light emitting portion and a light receiving portion disposed at a position facing a side along a short direction of the housing portion, so as to be configured to irradiate light onto a sample along a longitudinal direction of the housing portion and to receive light transmitted through the sample.

### (Configuration 9)

The concentration measuring apparatus of configuration 8, including a sample temperature sensor at a position facing a side along a longitudinal direction of the housing portion.

### (Configuration 10)

The concentration measuring apparatus of configuration 9, disposed so that a height of a light path from the light emitting portion to the light receiving portion is positioned within a height range of a measurement target range of the sample temperature sensor.

### (Configuration 11)

The concentration measuring apparatus of configuration 9 or 10, in which the sample temperature sensor is provided to face a side opposite to a side on which the projection is formed.

### (Configuration 12)

The concentration measuring apparatus of any of configurations B to 11, including a cell insertion sensor provided below the light emitting portion and the light receiving portion and disposed at a position facing the housing portion, in which, after insertion of the optical cell is detected by the cell insertion sensor, the light emitting portion and the light receiving portion execute a process to acquire transmittance or absorbance information of the optical cell itself as a reference.

### (Configuration 13)

The concentration measuring apparatus of any of configurations 9 to 12, including a sample detection sensor provided above the light emitting portion and the light receiving portion and disposed at a position facing the housing portion, in which, after lapse of a predetermined time period after the sample detection sensor detects injection of a sample into the optical cell, an acquisition process of temperature information by the sample temperature sensor, and an acquisition process of transmittance or absorbance information of a sample by the light emitting portion and the light receiving portion is executed.

### Effect of the Invention

According to the optical cell or the concentration measuring apparatus provided with the same of the present invention, it is possible to enhance workability or measurement accuracy.

### BRIEF DESCRIPTION OF THE DRAWINGS

FIG. 1 is a perspective view showing an external appearance of a concentration measuring apparatus of the embodiment of the present invention.

FIG. 2 is a block diagram schematically illustrating a configuration of the concentration measuring apparatus of the embodiment.

FIG. 3 is a perspective view showing an external appearance of an optical cell of the embodiment.

FIG. 4 is a plan view showing the optical cell of the embodiment.

FIG. 5 is a cross-sectional view showing the optical cell.

FIG. 6 shows a receiving portion of the optical cell of the concentration measuring apparatus.

FIG. 7 is a cross-sectional view of a cell holder unit of the concentration measuring apparatus of the embodiment.

FIG. 8 is a flowchart schematically illustrating the processing operations of the concentration measuring apparatus of the embodiment.

### EMBODIMENTS FOR CARRYING OUT THE INVENTION

The embodiment of the present invention is described specifically below together with the drawings. The embodiment given below is one of the embodiments upon embodying the present invention and is not intended to limit the invention within such a scope.

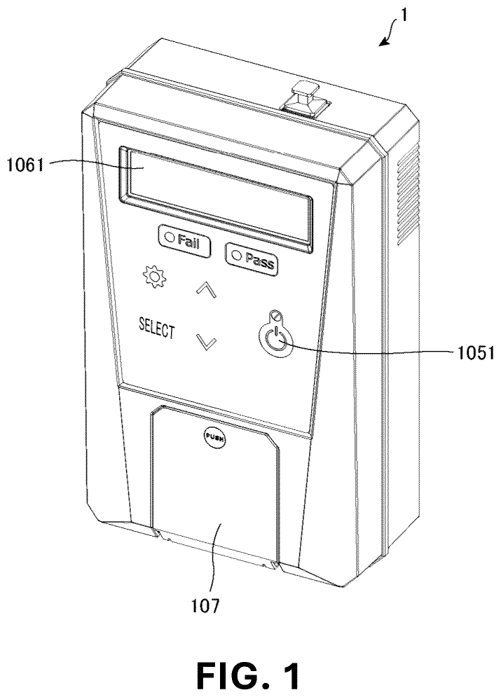

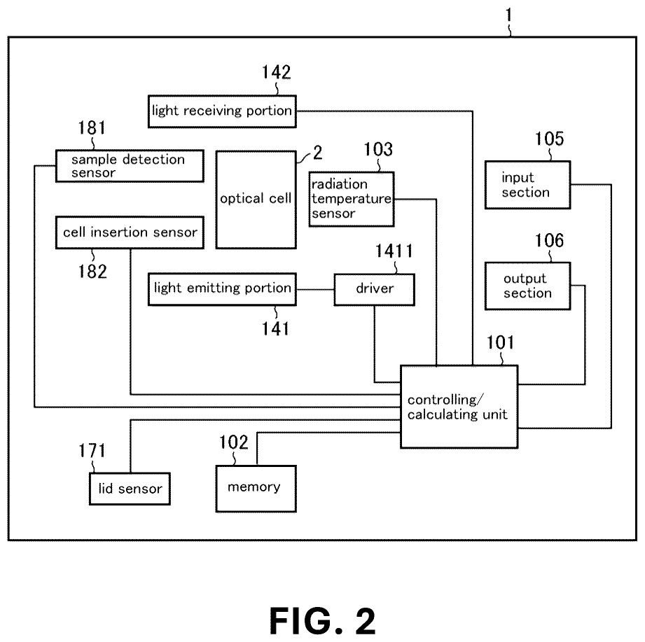

FIG. 1 is a perspective view showing an external appearance of a concentration measuring apparatus of an embodiment according to the present invention, and FIG. 2 is a block diagram schematically illustrating the configuration of the concentration measuring apparatus of the embodiment.

A concentration measuring apparatus 1 of this embodiment is used for measuring concentration based on measurements of temperature and transmittance or absorbance of disinfectant solutions such as glutaral solution or phthalal solution having correlation between temperature, transmittance or absorbance, and concentration, the concentration measuring apparatus 1 includes:
an optical cell 2 housing a disinfectant solution,
a radiation temperature sensor 103 that functions as both of a sample temperature sensor for measuring the temperature of the disinfectant solution and an ambient temperature sensor for measuring ambient temperature,
a light emitting portion 141 and a light receiving portion 142, which are optical sensors for measuring the transmittance or absorbance of the disinfectant solution,
a memory 102 in which various data, programs, etc. necessary for the operation of the apparatus are constantly or temporarily stored,
an input section 105 that serves as a user interface, with input means such as a power button 1051 and an operation button,
an output section 106 that serves as a user interface, with output means such as a display screen 1061 and an indicator,
a cover 107 that serves as a lid covering the optical cell 2 to prevent external light from entering when the optical cell 2 is mounted in the apparatus,
a lid sensor 171 that senses opening and closing of the
a cell insertion sensor 182 for detecting that the optical cell 2 has been mounted in the apparatus,
a sample detection sensor 181 for detecting that the sample (disinfectant solution) has been injected into the optical cell 2 mounted in the apparatus, and
a controlling/calculating unit 101 that controls each part of the apparatus, performs various calculations, and also functions as a concentration measuring section.

On “transmittance or absorbance” given above, since an absorbance is a logarithm of reciprocal of transmittance, and the difference between transmittance and absorbance does not make a conceptual difference in adaptation of the present invention (for example, when treated as an absorbance, conversion based on the above relationship formula should be done), the description is hereinafter simply referred to as “transmittance”.

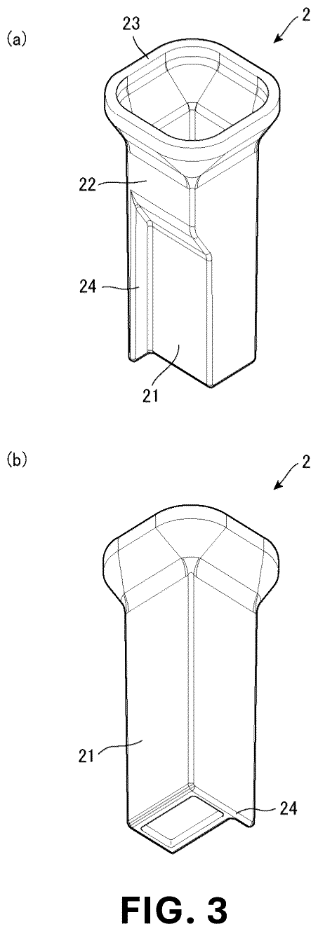

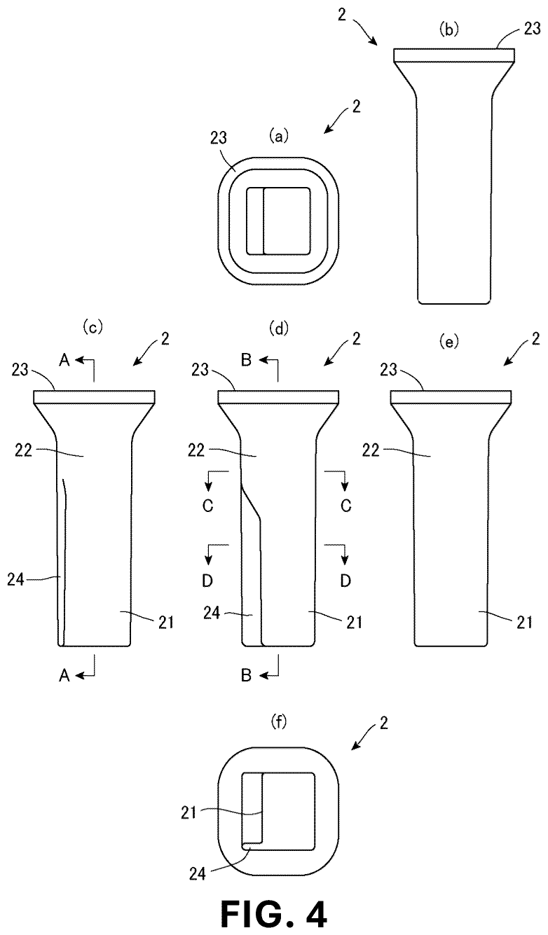

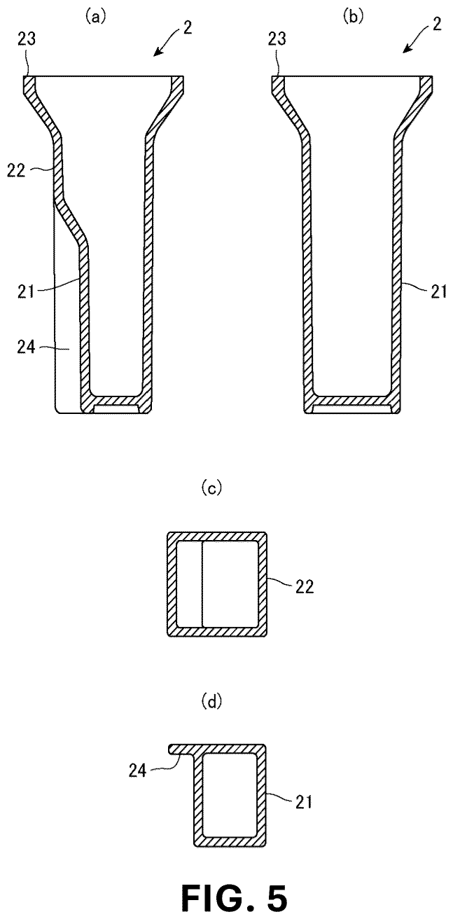

FIGS. 3 to 5 show the optical cell, in which FIG. 3(a) is a perspective view seen from the top, FIG. 3(b) is a perspective view seen from the bottom, FIG. 4(a) is a top view, FIG. 4(b) is a right side view, FIG. 4(c) is a left side view, FIG. 4(d) is a front view, FIG. 4(e) is a back view, FIG. 4(f) is a bottom view, FIG. 5(a) is a cross-sectional view along A-A line in FIG. 4(c), FIG. 5(b) is a cross-sectional view along B-B line in FIG. 4(d), FIG. 5(c) is a cross-sectional view along C-C line in FIG. 4(d), and FIG. 5(d) is a cross-sectional view along D-D line in FIG. 4(d).

The optical cell 2 is a container formed of a member that transmits light emitted by the light emitting portion 141, and houses a sample (disinfectant solution) of a few cc. The optical cell 2 is attachable to and removable from the concentration measuring apparatus 1, which is basically a disposable member.

As shown in FIGS. 3 to 5, the optical cell 2 of this embodiment has a configuration including:
a housing portion 21 for housing a sample, having a shape with a longitudinal direction and a short direction in the horizontal cross section at the lower side of the optical cell 2,
an injection inlet portion 23 formed at an upper end of the optical cell 2 with a cross-sectional area of horizontal cross-section (outer diameter shape of horizontal cross-section) formed larger than the housing portion 21,
an introducing portion 22 formed between the injection inlet portion 23 and the housing portion 21 with a cross sectional area of the horizontal cross-section (outer diameter shape of horizontal cross-section) formed larger than the housing portion 21 and smaller than the injection inlet portion 23, and
a projection 24 extending outward along the short direction from a side along the longitudinal direction of the housing portion 21.

In this embodiment, the housing portion 21 has a substantially rectangular shape in horizontal cross-section, and the introducing portion 22 has a substantially square shape in horizontal cross-section. The injection inlet portion 23 consecutive to the introducing portion 22 has a square shape with rounded corners at its upper end. Between the housing portion 21 and the introducing portion 22, and between the introducing portion 22 and the injection inlet portion 23, respectively, there is a shape transition portion whose shape gradually changes from one cross-sectional shape to the other.

By having the above configuration, the optical cell 2 of this embodiment has excellent workability for sample injection and can maintain measurement accuracy while reducing the amount of sample required for measurement.

Namely, the injection inlet portion 23 has a square shape with rounded corners close to a circle, which provides excellent workability for injecting a sample using a pipette or syringe. In addition, by making the housing portion 21 rectangular in cross-section, the volume of the housing portion 21 in which reduced to about 5 ml to about 2 ml). The reduced volume of liquid that should be injected improves workability as well as providing the effect of not wasting the disinfectant solution.

In addition, the housing portion 21 is rectangular in cross-section, namely, has a longitudinal direction in the horizontal cross-sectional view, which secures an optical path length for measurement by the optical sensor, thus making it possible to maintain measurement accuracy while reducing the capacity. Furthermore, the shape with a longitudinal direction (i.e., having sides with large area) secures a measurement area by the radiation temperature sensor 103, thus maintaining measurement accuracy while reducing the capacity.

In addition, by having a small volume and having a larger surface area per volume than a square cross-section due to the rectangular cross-section, an effect can be obtained in which thermal equilibrium of the disinfectant solution becomes faster (faster thermal equilibrium in cases where the optical cell and the disinfectant solution have different temperatures).

The housing portion 21, having a rectangular cross-section is configured to be offset to one side (right side) with respect to the introducing portion 22 having a square cross-section, and as a result, the side opposite to the side on which the projection 24 is formed in the housing portion 21 and introducing portion 22 (right side) is formed as a continuous plane. As a result, one side (right side) of the housing portion 21 and the introducing portion 22 is formed as a continuous plane without any unevenness, and the degree of freedom of installation of the radiation temperature sensor 103 in a position opposite to this side is increased.

In this embodiment, the projection 24 is formed to extend a side (back) of the housing portion 21 along the short direction, forming a short extension that extends outward along the short direction of the housing portion 21 in the bottom shape of the housing portion 21 (see FIG. 4(f)).

The projection 24 configures the short extension at the bottom of the optical cell 2 that extends the short direction of the housing portion 21, thereby improving stability when the optical cell 2 is made to stand.

The projection 24 is not rotationally symmetrical in the cross-sectional view of the optical cell 2, and the receiving portion 109 of the concentration measuring apparatus 1 described below has a corresponding shape, so that the optical cell 2 can always be installed in a constant direction. The constant insertion direction of the optical cell improves the stability of measurement accuracy.

The concentration measuring apparatus 1 includes a receiving portion 109 into which the optical cell 2 is inserted.

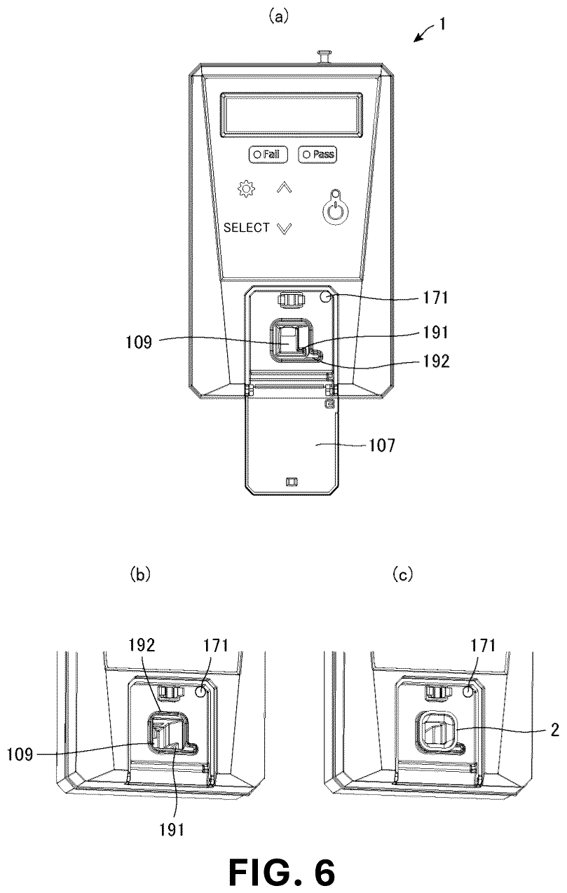

FIG. 6(a) shows a state where the cover 107 of the concentration measuring apparatus 1 is open, FIG. 6(b) is an enlarged perspective view of the receiving portion 109, and FIG. 6(c) shows a state where the optical cell 2 is mounted in FIG. 6(b).

The receiving portion 109 has a shape corresponding to an outer diameter shape of the optical cell 2 and has a recess 191 for receiving the projection 24 of the optical cell 2 only in a predetermined direction so that the optical cell 2 can always be mounted in a specific direction.

Since the receiving portion 109 has a shape corresponding to the outer diameter shape of the optical cell 2, the optical cell 2 can be mounted to the concentration measuring apparatus 1 at a fixed position without rattling. This improves the stability of measurement accuracy.

The receiving portion 109 has a marking 192 indicating a correct insertion direction of the optical cell 2. The marking imitates the cross-sectional shape of the optical cell 2 (indicating the direction of the projection 24) to improve usability.

The radiation temperature sensor 103 is provided in the optical cell 2 mounted to the concentration measuring apparatus 1 at a position facing the range containing the disinfectant solution, and measures the temperature of a sample (disinfectant solution) in a non-contact manner.

The radiation temperature sensor (sample temperature sensor) 103, with the optical cell 2 mounted in the concentration measuring apparatus 1, is positioned on the side of the housing portion 21 of the optical cell 2 along the longitudinal direction and facing the side opposite to the side where the projection 24 is formed (right side). As mentioned above, the right side of the housing portion 21 is formed as a continuous plane without any unevenness, and the degree of freedom of installation of the radiation temperature sensor 103 is increased by positioning the radiation temperature sensor 103 at a position facing this side. The right side of the housing portion 21 is a plane along the longitudinal direction and has a wide area, making it easy to secure a measurement area for the radiation temperature sensor 103.

The radiation temperature sensor 103 is connected to a controlling/calculating unit 101, and reading of sensor values, etc. is controlled by the controlling/calculating unit 101.

The light emitting portion 141 and the light receiving portion 142, which are optical sensors for measuring the transmittance of the disinfectant solution, are respectively arranged so that an optical axis of the light emitting portion 141 passes through the disinfectant solution in the optical cell 2 and the light receiving portion 142 can receive the light that has passed through the disinfectant solution.

The light emitting portion 141 and the light receiving portion 142 are disposed, with the optical cell 2 mounted in the concentration measuring apparatus 1, at a position facing a side along the short direction of the housing portion 21 of the optical cell 2, and are configured to irradiate light onto the sample along the longitudinal direction of the housing portion 21 and to receive light transmitted through the sample. In this embodiment, the light emitting portion 141 is arranged in a position facing the back of the housing portion 21 and the light receiving portion 142 is arranged in a position facing the front of the housing portion 21.

The light emitting portion 141 and the light receiving portion 142 are arranged so that the height of the light path from the light emitting portion 141 to the light receiving portion 142 is located within the height range of a measurement area (measurement target range) of the radiation temperature sensor (sample temperature sensor) 103.

In this example, the light emitting portion 141 is arranged to face one side (back) of the optical cell 2 and the light receiving portion 142 is arranged to face the opposite side (front), and the light path is within the height range of the measurement target range of the sample temperature sensor. However, the light emitting portion 141 and the light receiving portion 142 can be arranged in any configuration as long as they are capable of receiving light that has passed through the disinfectant solution.

The light emitting portion 141 is connected to the controlling/calculating unit 101 via a driver circuit 1411 that drives the light emission, and the timing of the light emission, etc. is controlled by the controlling/calculating unit 101.

The light receiving portion 142 is also connected to the controlling/calculating unit 101, and control of sensor value reading, calculation process of transmittance based on the sensor values, etc. are carried out by the controlling/calculating unit 101.

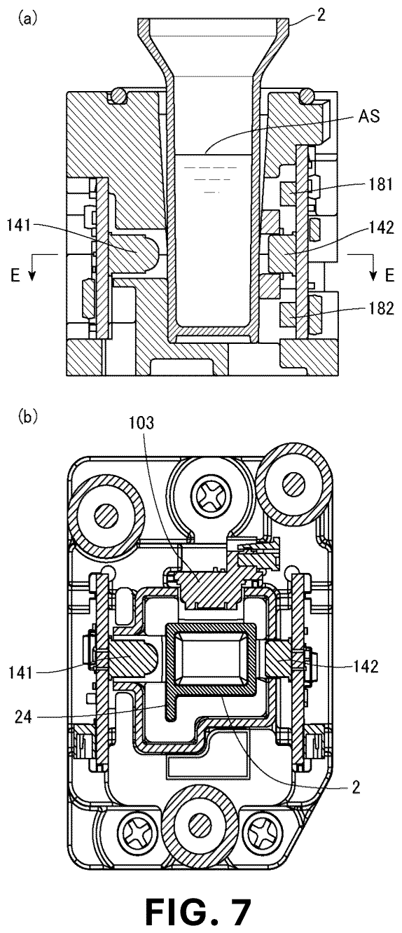

FIG. 7 shows a cross-sectional view of a cell holder unit that holds the optical cell 2 to be inserted in the apparatus and a substrate on which each sensor is mounted, FIG. 7(a) is a vertical cross-sectional view, and FIG. 7(b) is a horizontal cross-sectional view along E-E line in FIG. 7(a).

As understood from FIG. 7, the light emitting portion 141 and the light receiving portion 142 are configured to irradiate light to the sample, the disinfectant solution AS, along the longitudinal direction of the housing portion 21 and to receive light transmitted through the disinfectant solution AS. This secures the optical path length for measurement by the optical sensor, thus making it possible to improve measurement accuracy of transmittance of the disinfectant solution AS while reducing the capacity.

The radiation temperature sensor 103 is positioned to face a surface along the longitudinal direction of the housing portion 21 (surface with a large area) and facing the surface opposite to the surface where the projection 24 is formed.

Furthermore, the radiation temperature sensor 103, the light emitting portion 141, and the light receiving portion 142 are arranged at the same height, and “the light path is within the height range of the measurement target range of the sample temperature sensor”.

This configuration makes it possible to measure the liquid temperature in the optical path (i.e., the portion where the transmittance is measured), which enables good measurement accuracy.

Both the sample detection sensor 181 and the cell insertion sensor 182 are also configured from the optical sensors (light emitting portion and light receiving portion).

The cell insertion sensor 182, which is a sensor for detecting that the optical cell 2 has been mounted in the apparatus, is positioned below the light emitting portion 141 and the light receiving portion 142 and faces the housing portion 21, as shown in FIG. 7(a). By being positioned below the light emitting portion 141 and the light receiving portion 142, the presence of the optical cell 2 in the position facing the light emitting portion 141 and the light receiving portion 142 is secured when the optical cell 2 is detected by the cell insertion sensor 182.

The sample detection sensor 181, which is a sensor for detecting that the disinfectant solution AS has been injected into the optical cell 2 mounted in the apparatus, is positioned above the light emitting portion 141 and the light receiving portion 142 and faces the housing portion 21. By being positioned above the light emitting portion 141 and the light receiving portion 142, the presence of the disinfectant solution AS in the optical cell 2 in the position facing the light emitting portion 141 and the light receiving portion 142 is secured in the state where the disinfectant solution AS in the optical cell 2 is detected by the sample detection sensor 181.

Both the sample detection sensor 181 and the cell insertion sensor 182 detect that the optical cell 2 has been inserted and that the disinfectant solution AS has been injected by changes in reflectance (level of light received at the light receiving portion).

The sample detection sensor 181 and the cell insertion sensor 182 are connected to the controlling/calculating unit 101, and control of reading the sensor values (and emission of light therefor) and various determination processes given above based on the sensor values (change of reflectance) are carried out by the controlling/calculating unit 101.

An input section 105 and an output section 106, which are user interfaces, can be any input interface such as a button, touch panel, or voice input section, or any output interface such as a visual display apparatus such as an indicator or a display screen, or an auditory output section such as a speaker. The input/output sections are not limited to an interface to the user, but may be any input/output sections for input/output of information to/from other devices.

A lid sensor 171 is also configured from the optical sensors (light emitting portion and light receiving portion) and is positioned facing the cover 107 in the closed state to detect the opening and closing of the cover 107 by changes in reflectance (light receiving level at the light receiving portion).

The lid sensor 171 is also connected to the controlling/calculating unit 101, and control of reading the sensor values (and emission of light therefor) and determination process of opening/closing of the cover 107 based on the sensor values (change of reflectance) are carried out by the controlling/calculating unit 101.

Although the cell insertion sensor 182 and the lid sensor 171 are configured from optical sensors in this example, the present invention is not limited thereto. For example, the cell insertion sensor and the lid sensor may be configured by a sensor that detects physical contact conditions.

In the memory 102, programs to execute the processes described below and data necessary to execute the processes described below (and various other data and programs necessary for the operation of the apparatus) are stored (constantly or temporarily).

The memory 102 may use any storage device capable of constantly or temporarily storing this information.

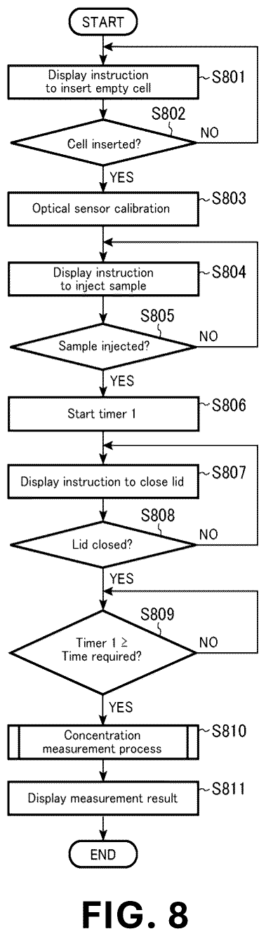

The controlling/calculating unit 101 controls each part of the apparatus and performs various calculation processes, and is configured using any semiconductor devices that perform calculation process equipped with a CPU (Central Processing Unit), such as a microcomputer, for example. The controlling/calculating unit 101 has the function of executing the processes described in FIG. 8 below, based on the program stored in the memory 102, while controlling each sensor, etc.

Although omitted in the drawing, it is of course possible for the controlling/calculating unit 101 to be connected to each section via A/D conversion circuits, various filter circuits, etc. as necessary (properly providing circuits to create proper signals as input/output to the controlling/calculating unit 101).

In this example, the processing part of each function is implemented in software on a general-purpose device (configured by a program operating on the controlling/calculating unit 101); however, a part or all of each may be configured in hardware (e.g., by a dedicated IC, etc.).

Next, with reference to FIG. 8, the processing operation of the part of the concentration measuring apparatus 1 that is mainly related to the present invention will be explained.

The process in FIG. 8 is executed when the start of the concentration measurement process is instructed, for example, by pressing down a power button 1051.

In step 801, a process is executed to display a message on a display screen 1061 instructing to set an empty optical cell 2 into the concentration measuring apparatus 1.

In subsequent step 802, whether or not the optical cell 2 has been inserted is monitored based on the sensor value of the cell insertion sensor 182. Until the optical cell 2 is inserted, the message display process of step 801 is continued (step 802: No→step 801), and if it is determined that the optical cell 2 has been inserted (step 802: Yes), the process moves to step 803.

In step 803 after the empty optical cell 2 has been set in the concentration measuring apparatus 1, a calibration process of the optical sensors (light emitting portion 141 and light receiving portion 142) is performed. The calibration is to measure the transmittance (reference) of the empty optical cell 2 and to calibrate the measurement by the optical sensors based on the value obtained thereby (value specific to the empty optical cell 2). Since the optical cell 2 is supposed to be disposable and is replaced by a different (new) optical cell each time, the sensors are calibrated based on the transmittance specific to each optical cell 2 to improve measurement accuracy. Since the calibration process itself is based on the same calculation method as the conventional method, a detailed explanation is omitted.

In steps 802 and 803, “after insertion of the optical cell is detected by the cell insertion sensor, the light emitting portion and the light receiving portion execute a process to acquire transmittance or absorbance information of the optical cell itself as a reference” is performed.

When it is determined in the process of step 802 that the optical cell that already contains the disinfectant solution has been set in the apparatus, an error process may be performed, for example, by displaying a warning requesting insertion of an empty cell.

After the calibration process of the optical sensor is completed, the process moves to step 804 and a message is displayed on the display screen 1061 instructing the injection of the disinfectant solution into the cell.

In subsequent step 805, whether or not a required amount of disinfectant solution has been injected into the optical cell 2 is monitored based on the sensor value of the cell insertion sensor 181. Until a required amount of disinfectant solution is injected into the optical cell 2, the message display process of step 804 is continued (step 805: No→step 804), and when it is determined that a required amount of disinfectant solution has been injected (step 805: Yes), the process moves to step 806 and a timer 1 is started (starts measuring time). While the example herein starts the timer 1 after a required amount of disinfectant solution has been injected into the optical cell 2, the timer 1 may be started after the cover 107 is closed (starts measuring time after step 808).

In subsequent step 807, a message instructing closure of the cover 107 is displayed on the display screen 1061.

In subsequent step 808, whether or not the cover 107 has been closed is monitored based on the sensor value of the lid sensor 171. Until the cover 107 is closed, the message display process of step 807 is continued (step 808: No→step 807), and when it is determined that the cover 107 has been closed (step 808: Yes), the process moves to step 809.

In step 809, it is determined whether or not the timer 1 is at a predetermined value or more, and after reaching the predetermined value or more, the process moves to step 810, the concentration determination process.

Step 809 is a process of waiting for a predetermined period of time after the disinfectant solution has been injected into the optical cell 2.

Immediately after injection of the disinfectant solution, the temperature and transmittance measurements may easily vary due to convection of the liquid, bubbles, etc. When there is a difference between the temperature of the cell and the temperature of the disinfectant solution, the liquid temperature may not be stable immediately after the injection of the disinfectant solution. The process in step 809 improves measurement accuracy of the transmittance and liquid temperature by having the measurement performed after a predetermined period of time (waiting for the injected disinfectant solution to settle).

“Predetermined period of time” can be determined properly according to the configuration of the apparatus and the target problem. For example, for the problem of liquid movement or bubbles immediately after injection of the disinfectant solution, for example, the disinfectant solution may be allowed to stand for 10 to 15 seconds.

In step 810, a concentration determination process is executed.

In this process, the transmittance and temperature (and environmental temperature, if necessary) of the disinfectant solution are measured, and the concentration of the disinfectant solution is calculated based on these measurements. Since the process itself of calculating concentration based on the transmittance and temperature measurements is based on the conventional calculation method, a detailed explanation is omitted.

In steps 805-810, “after lapse of a predetermined time period after the sample detection sensor detects injection of a sample into the optical cell, an acquisition process of temperature information by the sample detection sensor, and an acquisition process of transmittance or absorbance information of a sample by the light emitting portion and the light receiving portion” are executed.

In step 811, based on the concentration measured in step 810, the concentration is output from the output section 106.

The output process may be one using an indicator to show whether or not the predetermined concentration (e.g., 0.3%) is met (e.g., turning on the Fail or Pass lamp), or one specifically displaying the concentration as a numerical value.

As mentioned above, according to the optical cell 2 of this embodiment, it is possible to enhance workability or measurement accuracy.

Specifically, the injection inlet portion 23 has a square shape with rounded corners close to a circle, which provides excellent workability for injecting a sample into the optical cell using a pipette or syringe.

In addition, by making the housing portion 21 rectangular in cross-section, the volume of the housing portion 21 in which the sample enters is reduced, as well as improving workability and also preventing waste of the disinfectant solution.

In addition, the housing portion 21 is rectangular in horizontal cross-section, which secures the optical path length for measurement by the optical sensor, thus making it possible to improve measurement accuracy while reducing the capacity.

Furthermore, the shape with a longitudinal direction (i.e., having a large area of sides) secures the measurement area by the radiation temperature sensor 103, thus enhancing measurement accuracy while reducing the capacity.

One side (right side) of the housing portion 21 and the introducing portion 22 is formed as a continuous plane without unevenness, and the degree of freedom of installation of the radiation temperature sensor 103 in a position facing this side is increased.

The projection 24 forms the short extension in the bottom shape of the housing portion 21 that extends outward along a short direction of the housing portion 21, thereby improving stability when the optical cell 2 is made to stand.

The projection 24 is not rotationally symmetrical in the cross-sectional view of the optical cell 2, and the receiving portion 109 of the concentration measuring apparatus 1 has a corresponding shape, so that the optical cell 2 can always be installed in a constant direction. The constant insertion direction of the optical cell improves the stability of measurement accuracy.

Further, according to the concentration measuring apparatus 1 provided with the optical cell 2, it is possible to enhance workability or measurement accuracy.

Specifically, the light emitting portion 141 and the light receiving portion 142 being arranged so that the optical path is located within the height range of the measurement area of the radiation temperature sensor 103 makes it possible to measure the liquid temperature in the optical path (i.e., the portion where the transmittance is measured), which enables good measurement accuracy.

By the sample detection sensor 181 positioned below the light emitting portion 141 and the light receiving portion 142, the condition where the presence of the optical cell 2 in the position facing the light emitting portion 141 and the light receiving portion 142 is secured can be detected, and since the calibration process is automatically executed, workability and measurement accuracy are improved.

By the cell insertion sensor 182 positioned above the light emitting portion 141 and the light receiving portion 142, the condition where the presence of the disinfectant solution in the optical cell 2 in the position facing the light emitting portion 141 and the light receiving portion 142 (on the light path) is secured can be detected. In addition, the lid sensor 171 detects that the cover 107 has been closed and the concentration measurement process is automatically executed (conversely, the concentration measurement process is not executed unless the cover 107 is closed), thereby improving workability and measurement accuracy.

In the embodiment, an example was given where the projection 24 of the optical cell 2 is formed along the housing portion 21 from the top portion to the bottom portion thereof (i.e., a plate or wing-shaped member) ; however, the present invention is not limited thereto (the projection is not limited to a plate or wing-shaped member). As long as the projection is at least “a projection extending outward along a short direction from a side along the longitudinal direction of the housing portion”, the projection can only be formed in a part of the housing portion 21 in a height direction which can obtain an effect of defining the inserting direction of the optical cell. In this case, the effect of improving the self-supporting property of the optical cell can be obtained by making the projection forming “short extension” in the bottom portion, as in the embodiment.

The projection is not limited to one location, but may be provided in multiple locations as long as they are not rotationally symmetrical in a horizontal cross-sectional view.

In the present embodiment, an example is given where the projection 24 is formed to extend the side (back) of the housing portion 21 along the short direction; however, the invention is not limited thereto, and it is sufficient that the projection is at least “a projection extending outward along the short direction from the side along the longitudinal direction of the housing portion”. For example, the projection can be formed to extend from a central part of the side along the longitudinal direction of the housing portion outward along the short direction.

In the embodiment, a concentration measuring apparatus for measuring the concentration of disinfectant solutions such as glutaral solution and phthalal solution is given as an example; however, the invention is not limited thereto, and the concept of the present invention can be applied to any measuring apparatus for samples using an optical cell such as an absorptiometry.

In this embodiment, a radiation temperature sensor which is a non-contact temperature sensor is used as an example; however, the present invention is not limited thereto. Any temperature sensor can be used, for example, a contact-type temperature sensor such as thermocouples.

### DESCRIPTION OF REFERENCE NUMERALS

1 . . . concentration measuring apparatus
101 . . . controlling/calculating unit
102 . . . memory
103 . . . radiation temperature sensor (sample temperature sensor)
141 . . . light emitting portion
142 . . . light receiving portion
109 . . . receiving portion
191 . . . recess
181 . . . sample detection sensor
182 . . . cell insertion sensor
2 . . . optical cell
21 . . . housing portion
22 . . . introducing portion
23 . . . injection inlet portion
24 . . . projection (short extension)

1.-6. (canceled)

7. A concentration measuring apparatus for measuring concentration of a sample by absorptiometry comprising an optical cell, the optical cell comprising a housing portion having a longitudinal direction and a short direction in horizontal cross-section, and a projection extending outward from a side along a longitudinal direction of the housing portion along a short direction, wherein the sample is housed in the optical cell, wherein the concentration measuring apparatus comprises a receiving portion for receiving the optical cell and including a recess for receiving the projection only in a predetermined direction.

8. The concentration measuring apparatus of claim 7 comprising a light emitting portion and a light receiving portion disposed at a position facing a side along a short direction of the housing portion, so as to be configured to irradiate light onto a sample along a longitudinal direction of the housing portion and to receive light transmitted through the sample.

9. The concentration measuring apparatus of claim 8 comprising a sample temperature sensor at a position facing a side along a longitudinal direction of the housing portion.

10. The concentration measuring apparatus of claim 9 disposed so that a height of a light path from the light emitting portion to the light receiving portion is positioned within a height range of a measurement target range of the sample temperature sensor.

11. The concentration measuring apparatus of claim 9, wherein the sample temperature sensor is provided to face a side opposite to a side on which the projection is formed.

12. The concentration measuring apparatus of claim 8 comprising a cell insertion sensor provided below the light emitting portion and the light receiving portion and disposed at a position facing the housing portion,
wherein, after insertion of the optical cell is detected by the cell insertion sensor, the light emitting portion and the light receiving portion execute a process to acquire transmittance or absorbance information of the optical cell itself as a reference.

13. The concentration measuring apparatus of claim 9 comprising a sample detection sensor provided above the light emitting portion and the light receiving portion and disposed at a position facing the housing portion,
wherein, after lapse of a predetermined time period after the sample detection sensor detects injection of a sample into the optical cell, an acquisition process of temperature information by the sample temperature sensor, and an acquisition process of transmittance or absorbance information of a sample by the light emitting portion and the light receiving portion is executed.

14. An optical cell for housing a sample in a concentration measuring apparatus for measuring concentration of the sample by absorptiometry, the optical cell comprising:
a housing portion having a longitudinal direction and a short direction in horizontal cross-section and having a substantially rectangular shape,
a projection extending outward from a side along a longitudinal direction of the housing portion along a short direction,
an injection inlet portion formed at an upper end of the optical cell with a cross-sectional area of horizontal cross-section formed larger than the housing portion, and
an introducing portion positioned between the injection inlet portion and the housing portion with a cross-sectional area of horizontal cross-section formed larger than the housing portion,
wherein a side of the housing portion and the introducing portion opposite to a side on which the projection is formed is formed as a continuous plane.

15. The optical cell of claim 14, wherein the projection is a plate or wing-shaped member.
